(19) United States
(12) Patent Application Publication
(10) Pub. No.: US 2020/0184173 A1
(43) Pub. Date: Jun. 11, 2020

(54) FINGERPRINT SENSOR MODULE COMPRISING ANTENNA AND METHOD FOR MANUFACTURING A FINGERPRINT SENSOR MODULE

(71) Applicant: Fingerprint Cards AB, Göteborg (SE)

(72) Inventors: Di JIANG, Torslanda (SE); Karl LUNDAHL, Göteborg (SE); Hadayat KHAN, Linköping (SE)

(73) Assignee: Fingerprint Cards AB, Göteborg (SE)

(21) Appl. No.: 16/623,463

(22) PCT Filed: Jun. 21, 2018
(86) PCT No.: PCT/SE2018/050673

§ 371 Date: Dec. 17, 2019

(30) Foreign Application Priority Data
Jun. 28, 2017 (SE) 1750836-7

(51) Int. Cl. G06K 9/00; G06K 19/07; G06K 19/077

(52) U.S. Cl. CPC G06K 9/0002; G06K 19/07773; G06K 19/0723; G06K 19/0718

(57) ABSTRACT

There is provided a fingerprint sensor module comprising a fingerprint sensor device. The fingerprint sensor device comprises a sensing array consisting of a plurality of sensing elements, the sensor device being configured to acquire an image of a finger placed on a sensing surface of the fingerprint sensor module. The fingerprint sensor module further comprises a substrate comprising an opening, wherein the fingerprint sensor device is arranged in the opening of the substrate and wherein the substrate comprises an antenna embedded in the substrate, the antenna being electrically connected to the fingerprint sensor device.

### FIELD OF THE INVENTION

The present invention relates to a fingerprint sensor module comprising an embedded antenna and to a method for manufacturing such a fingerprint sensor module.

### BACKGROUND OF THE INVENTION

As the development of biometric devices for identity verification, and in particular of fingerprint sensing devices, has lead to devices which are made smaller, cheaper and more energy efficient, the possible applications for such devices are increasing. Fingerprint sensing in particular has been adopted in more and more applications such as consumer electronic devices and smart cards due to small form factor, relatively beneficial cost/performance factor and high user acceptance.

In particular, fingerprint sensor integration in smart cards is increasingly requested by the market. However, the requirements of the fingerprint sensor in a smart card may be different compared to when the sensor is used in a smartphone. For example, since the cost of a smart card is significantly lower than the cost of smartphone, it is even more desirable to reduce the cost of the fingerprint sensor for a smart card. Moreover, the access to power may be more limited in a smart card compared to in a smartphone.

Accordingly, it is desirable with improved and efficient Integration of a fingerprint sensor in smart cards.

### SUMMARY

In view of above-mentioned and other drawbacks of the prior art, it is an object of the present invention to provide an improved fingerprint sensor module for integration in a smart card.

According to a first aspect of the invention, there is provided a fingerprint sensor module comprising: a fingerprint sensor device comprising a sensing array consisting of a plurality of sensing elements, the sensor device being configured to acquire an image of a finger placed on a sensing surface of the fingerprint sensor module; a substrate comprising an opening; wherein the fingerprint sensor device is arranged in the opening of the substrate and wherein the substrate comprises an antenna embedded in the substrate, the antenna being electrically connected to the fingerprint sensor device.

The fingerprint sensor module can be considered to comprise the fingerprint sensor device and a package structure at least partially enclosing the fingerprint sensor device. The sensing array of the fingerprint sensor device is an array comprising a plurality of individual sensing elements, also referred to as pixels. In a capacitive fingerprint sensing device, each sensing element comprises an electrically conductive plate and associated sensing and readout circuitry for detecting a capacitive coupling between each sensing element and a finger placed on a sensing surface of the fingerprint sensor module. It should however be noted that various embodiments of the present invention are equally applicable for other types of fingerprint sensor technologies, such as optical, thermal and ultrasonic fingerprint sensor devices.

The opening of the substrate is configured to receive and hold the fingerprint sensor device and the shape and size of the opening typically mirrors the shape and size of the fingerprint sensor module.

The antenna may advantageously be an RFID (Radio-frequency identification) antenna configured to communicate with a corresponding RFID device and also to provide power to the fingerprint sensor module by harvesting energy from radio waves transmitted by an RFID reader. Thereby, a fingerprint sensor module can be provided with power without the need for an external power supply. The antenna may for example be an NFC (Near-field communication) antenna configured according to existing standards for near field communication.

The present invention is based on the realization that a fingerprint sensor module comprising an embedded antenna provides additional functionality of the fingerprint sensor module and also more efficiently utilizes the area of the module.

Moreover, for a fingerprint sensor module integrated in a smart card, the antenna may enable the fingerprint sensor device to be powered up, using the energy collected from the embedded antenna, without waiting for the power supply from a controller chip of the smart card. If the antenna is only intended for energy collection, it will only act as a receiver, not a transmitter. An antenna acting as only a receiver will also simplify the antenna design. By using such an embedded antenna, the fingerprint sensor device can be powered up and initialized before the controller chip is of the smart card ready to communicate with the sensor chip. Also, for a fingerprint sensor module provided as an all-in-one solution, the need to fabricate another antenna on the smart card may be eliminated, which simplifies the card manufacture process.

According to one embodiment of the invention, the antenna may be arranged to encircle the opening comprising the fingerprint sensor device. The antenna may advantageously encircle the fingerprint sensor device, where the antenna performs a plurality of loops around the fingerprint sensor device. Thereby, the fingerprint sensor device is located within the antenna loop, which provides more efficient area utilization of the fingerprint sensor module. The specific configuration of the antenna, such as the size of the antenna and the number of loops, can be decided based in the intended application for the fingerprint sensor module.

According to one embodiment of the invention the antenna may be arranged below the fingerprint sensor device, on a side of the fingerprint sensor device opposite the side comprising the sensing array. For an antenna arranged below the fingerprint sensor device, the minimum size of the antenna is not restricted by the size of the fingerprint sensor device. Accordingly, it is possible to form an antenna having a smaller footprint area if the antenna is arranged below the fingerprint sensor device. Even though an antenna arranged below the fingerprint sensor device may be shielded by the fingerprint sensor device to some degree, the strength of the signal reaching the antenna may still be sufficient, especially so if the signal does not have to propagate through the fingerprint sensor device.

According to one embodiment of the invention, the substrate may comprise a plurality of conductive layers, wherein the antenna is formed in the plurality of conductive layers of the substrate. Thereby, additional degrees freedom is provided when designing the antenna. In particular, arranging the antenna in multiple layers facilitates tuning impedance, efficiency, Q-factor and frequency range of the antenna. The substrate may for example comprise up to 20 layers of conductive material to be used for the antenna design.

According to one embodiment of the invention, the substrate may be a laminate substrate comprising a plurality of carrier layers interspaced with a plurality of electrically conductive layers. Thereby, a relatively straightforward manner of forming the antenna is provided, where the antenna pattern of the conductive layers are sandwiched between non-conductive carrier layers. The substrate may for example be an epoxy-based laminate substrate, such as an FR4 based PCB (printed circuit board) substrate.

According to one embodiment of the invention, the substrate may advantageously comprise a glass or ceramic material having a plurality of electrically conductive layers embedded therein. A glass or ceramic material may provide improved RF-properties of the antenna, thereby improving the antenna properties for some applications.

According to one embodiment of the invention, the opening of the substrate may be a recess in the substrate. Thereby, the fingerprint sensor module can be located in the recess and the antenna can be located either below the fingerprint sensor device or encircling the fingerprint sensor device.

According to one embodiment of the invention, the opening of the substrate may be a through hole through the substrate. An opening reaching all the way through the substrate is comparatively easy to manufacture, thereby providing a simplified manufacturing process for forming the fingerprint sensor module. By arranging the fingerprint sensor device in a through opening of the substrate, the whole thickness of the substrate can be used to house the fingerprint sensor module, thereby making it possible to minimize the overall thickness of the substrate.

According to one embodiment of the invention, the fingerprint sensor device may comprises at last one connection pad located adjacent to the sensing array, and wherein the fingerprint sensor device is electrically connected to the antenna via the connection pads. One or more connection pads of the fingerprint sensor device are advantageously formed simultaneously with top metal layer of electrically conductive sensing structures of a sensing array in a capacitive fingerprint sensor device. Thereby, the connection pads can be located in the same plane as the sensing array.

According to one embodiment of the invention, the electrical connection between the connection pad of the fingerprint sensor device and the antenna may be formed as a conductive trace located in the same plane as the connection pad. Thereby, a planar electrical connection can be formed between the connection pad and a corresponding connection location of the antenna, which is preferably also located in the same plane as the fingerprint sensor connection pad.

According to one embodiment of the invention, the fingerprint sensor module may further comprise a via connection in the substrate, wherein the connection pad is electrically connected to the antenna by means of the via connection. Thereby, the antenna itself may be embedded within the substrate with the via connection acting as the conductive path connection the fingerprint sensor device to the antenna.

According to one embodiment of the invention, the substrate may comprise at least one substrate connection pad for electrically connecting the fingerprint sensor module to external circuitry. The substrate connection pad may be located on either side of the substrate, and it is also possible that the substrate, and thereby the fingerprint sensor module, has a T-shaped profile to facilitate mounting of the fingerprint sensor module in a correspondingly shaped opening of a smart card, in which case the connection pad of the substrate may be located on the lower sides of the protruding portions of the T-shaped substrate.

The described fingerprint sensor module may also comprise additional electronic components, including both active and passive components, which may be associated with functionality of the fingerprint sensor device.

There is also provided a smart card comprising a fingerprint sensor module according to any one of the aforementioned embodiments, wherein the fingerprint sensor module is arranged in an opening of the smart card and electrically connected to smart card circuitry by means of the substrate connection pad.

According to a second aspect of the invention, there is provided a method for manufacturing a fingerprint sensor module, the method comprising: providing a fingerprint sensor device comprising a sensing array consisting of a plurality of sensing elements, the sensor device being configured to acquire an image of a finger placed on a sensing surface of the fingerprint sensor module; providing a substrate comprising an antenna embedded in the substrate, the substrate further comprising an opening for receiving the fingerprint sensor device; arranging the fingerprint sensor device in the opening; and forming an electrical connection between the fingerprint sensor device and the substrate.

According to one embodiment of the invention, the substrate opening may be an opening through the substrate, the method further comprising: arranging the substrate on a carrier; arranging the fingerprint sensor module on the carrier in the substrate opening with the sensing array facing the carrier; depositing a mold material covering a backside of the fingerprint sensor device and a backside of the substrate to mechanically attach the fingerprint sensor device to the substrate; removing the carrier; and forming an electrical connection between a connection pad located on the fingerprint sensor device adjacent to the sensing array and the antenna. The carrier may for example be an adhesive tape which may comprise PI, PET or any other similar polymer. The carrier may also be a glass or silicon wafer or plate that is coated with adhesive glue. The adhesiveness of this carrier can be later reset by UV light, thermal or mechanical sliding method. This is sometimes referred to as bonding and de-bonding technology where a device is attached to and subsequently removed from a carrier.

According to one embodiment of the invention, the substrate opening may be a recess in the substrate. The method further comprising: arranging the fingerprint sensor module in the substrate recess; depositing a mold material surrounding filling a space between the fingerprint sensor device and the sidewalls of the substrate recess to mechanically attach the fingerprint sensor device to the substrate; and forming an electrical connection between a connection pad located on the fingerprint sensor device adjacent to the sensing array and the antenna.

According to one embodiment of the invention the electrical connection between the fingerprint sensor device and the antenna may advantageously be formed in a redistribution layer (RDL) using a wafer-level fan-out process. Thereby, a simple way of connecting a comparatively small connection pad of the fingerprint sensor device to a potentially larger connection pad of the antenna is provided.

Additional effects and features of the second aspect of the invention are largely analogous to those described above in connection with the first aspect of the invention.

Further features of, and advantages with, the present invention will become apparent when studying the appended claims and the following description. The skilled person realize that different features of the present invention may be combined to create embodiments other than those described in the following, without departing from the scope of the present invention.

### BRIEF DESCRIPTION OF THE DRAWINGS

These and other aspects of the present invention will now be described in more detail, with reference to the appended drawings showing an example embodiment of the invention, wherein:

FIGS. 1A-B schematically illustrate a fingerprint sensor module according to an embodiment of the invention;

FIG. 2 is flow chart outlining the general steps of method for manufacturing a fingerprint sensor module according to an embodiment of the invention;

FIGS. 3A-E schematically illustrate steps of method for manufacturing a fingerprint sensor module according to an embodiment of the invention;

FIG. 4 schematically illustrates a fingerprint sensor module according to an embodiment of the invention;

FIG. 5 is flow chart outlining the general steps of method for manufacturing a fingerprint sensor module according to an embodiment of the invention;

FIGS. 6A-C schematically illustrate steps of method for manufacturing a fingerprint sensor module according to an embodiment of the invention; and

FIG. 7 schematically illustrate a smartcard comprising a fingerprint sensor module according to an embodiment of the invention.

### DETAILED DESCRIPTION OF EXAMPLE EMBODIMENTS

In the present detailed description, various embodiments of the system and method according to the present invention are mainly described with reference to a capacitive fingerprint sensor device. However, various embodiments of the invention are equally applicable also to other types of fingerprint sensors, such as optical, ultrasound and thermal fingerprint sensors.

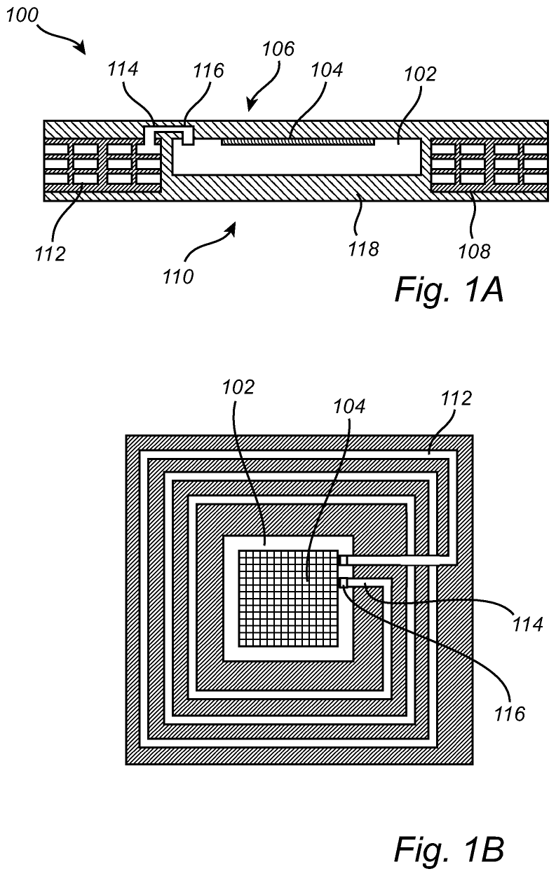

FIG. 1A schematically illustrates a side view of a fingerprint sensor module 100 according to an embodiment of the invention. The fingerprint sensor module 100 comprises a fingerprint sensor device 102 which in turn comprises a sensing array 104 consisting of a plurality of sensing elements. The sensor device 102 is configured to acquire an image of a finger placed on a sensing surface 106 of the fingerprint sensor module 100. In a capacitive finger sensor device 102, each sensing element comprises an electrically conductive structure and associated detection circuitry connected to the electrically conductive structure and configured to acquire a signal proportional to the capacitive coupling between each sensing structure and a finger placed on the sensing surface 106 of the fingerprint sensor module 100.

The fingerprint sensor module 100 further comprises a substrate 108 comprising an opening 110, and the fingerprint sensor device 102 is arranged in the opening 110 of the substrate 108. The substrate 108 further comprises an electrically conductive antenna 112 embedded in the substrate 108, the antenna 110 being electrically connected to the fingerprint sensor device 102. Here, the electrical connection 114 between the antenna and the fingerprint sensor device 102 is a conductive trace 114 connecting the antenna 112 to a connection pad 116 of the fingerprint sensor device 102, located on the same side of the fingerprint sensor device 102 as the sensing array 104. However, it is also possible to form an electrical connection to the fingerprint sensor device 102 on the opposite side, i.e. the backside, of the fingerprint sensor device 102.

As illustrated in FIG. 1A and in the top view of the of the fingerprint sensor module of FIG. 1B, the antenna 112 is arranged to surround the opening 110 of the substrate 108. Moreover, the antenna 112 is comprises antenna loops arranged in parallel in several layers of the substrate 108. The substrate may for example be a laminate substrate 108 where the antenna is located between layers of the laminate substrate 108. The substrate 108 may for example be a PCB substrate 108. However, it is also possible to provide an antenna in only one layer of the substrate 108.

The opening 110 of the substrate is a through opening reaching all the way through the substrate 108 and the fingerprint sensor device 102 is held in place by means of a mold material 118, an encapsulant or any other suitable filling material.

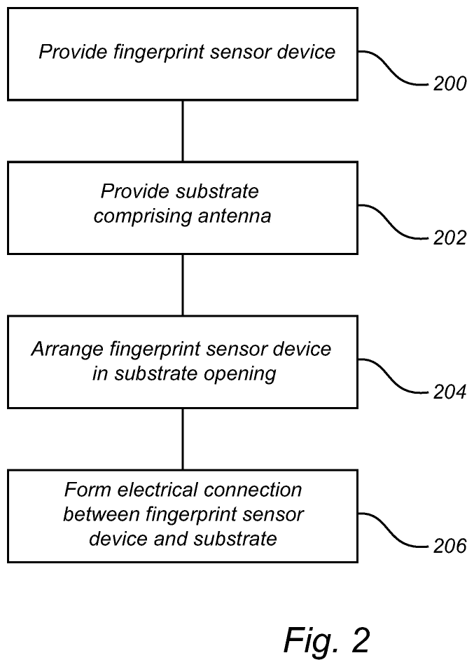

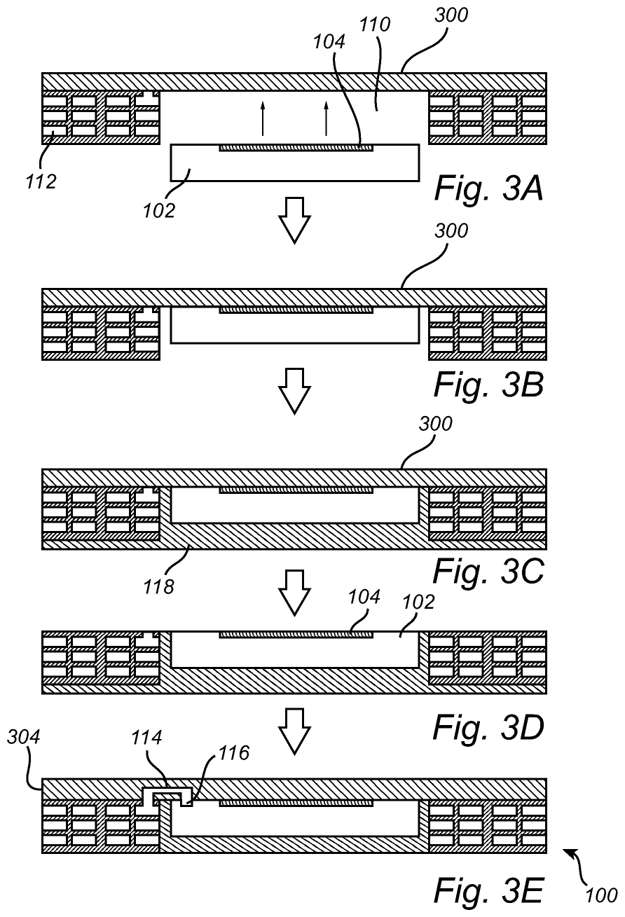

FIG. 2 is a flow chart outlining the general steps of a method for manufacturing fingerprint sensor module 100 according to an embodiment of the invention. The flow chart of FIG. 2 will be discussed with further reference to FIGS. 3A.C illustrating selected steps of a method for manufacturing the fingerprint sensor module 100.

The method comprises providing 200 a fingerprint sensor device 102 as described above in relation to FIG. 1A. A substrate 108 comprising an antenna 112 embedded in the substrate 108 is provided 202. The substrate is arranged on a carrier 300 such as an adhesive tape a wafer carrier, a plate carrier or the like as illustrated in FIG. 3A. The substrate 108 comprises an opening 110 for receiving the fingerprint sensor device 102.

The method further comprises arranging 204 the fingerprint sensor device 102 in the opening 110 as illustrated in FIG. 3B. Next, illustrated in FIG. 3C, a mold material 118 is deposited in the opening 110 to protect and to hold the fingerprint sensor device 102 in place in the substrate opening 110.

In the following step, illustrated in FIG. 3D, the carrier 300 is removed, or the fingerprint sensor module is removed from the carrier 300 such that the surface of the fingerprint sensor device 102 is exposed. This enables the formation 206 of an electrical connection 114 between the antenna 112 of the substrate 108 and connection pads 116 fingerprint sensor device 102 as illustrated in FIG. 3E. The electrical connection 114 may be formed directly between the fingerprint sensor device 102 and the antenna 112. It is also possible to connect the fingerprint sensor device 102 to routing circuitry or intermediate connection pads of the substrate which in turn are electrically connected to the antenna 112. The electrical connection 114 may be formed using metal electroplating or any other known metal deposition method. Moreover, the electrical connection between the fingerprint sensor device 102 and the antenna 112 may be located on the backside of the fingerprint sensor device 102 where a via connection may be provided to reach through the fingerprint sensor device 102.

Thereby, the fingerprint sensor device 102 is electrically connected to the antenna 112 such that the fingerprint sensor device 102 for example can receive energy received by the antenna 112.

FIG. 3E further illustrates depositing a protective layer 304 to cover the top surface of the fingerprint sensor module 100. It should be noted that the protective layer 304 may comprise an encapsulant or a coating. The protective layer 301 may further comprise a plurality of layers, such as an adhesive, a pigment layer, a dielectric layer and a top surface coating. The fingerprint sensor module 100 may also comprise a protective plate in the form of a glass or ceramic plate. Thereby, the fingerprint sensor module 100 is completed and ready form arranging in a device such as a smartcard.

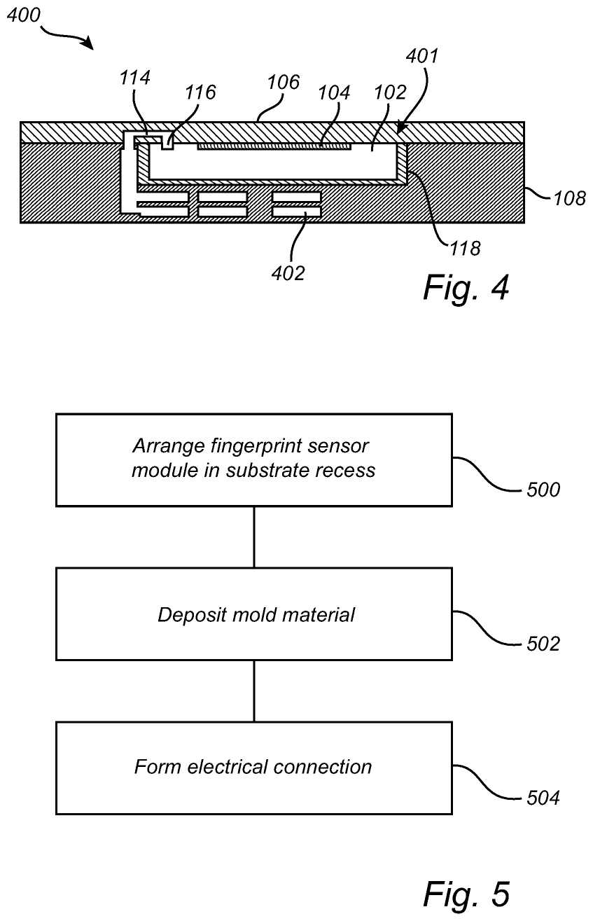

FIG. 4 schematically illustrates a fingerprint sensor module 400 according to an embodiment of the invention where the fingerprint sensor device 102 is arranged in a recess 401 of the substrate 108. The opening 401 in the substrate 108 is thereby not a through opening. Accordingly, the opening 401 should be seen as the portion of the substrate where substrate material has been removed to house the fingerprint sensor device 102. It is also possible to directly form a substrate 108 having the desired opening 110, 401. Moreover, the antenna 402 is here located underneath the fingerprint sensor device 102. This allows for the overall size of the fingerprint sensor module 400 to be reduced compared to if an antenna is arranged to encircle the fingerprint sensor device 102. However, it is equally well possible to arrange an antenna to encircle the fingerprint sensor device 102, even if the fingerprint sensor device 102 is located in a recess 401 and not in a through opening.

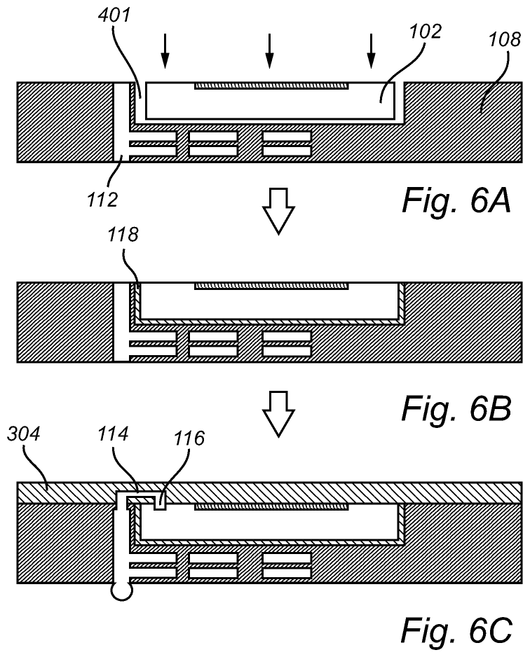

FIG. 5 is flow chart outlining the general steps of method for manufacturing a fingerprint sensor module 400 as illustrated in FIG. 4. The method will be discussed with further reference to FIGS. 6A-C illustrating selected steps of the method.

The method illustrated in FIGS. 6A-C is in many parts similar to the method discussed above with reference to FIG. 2 and FIGS. 3A-E. First, a substrate 108 comprising an opening in the form of a recess 401 is provided. The fingerprint sensor device 102 is then arranged 500 in the substrate recess 401 as illustrated in FIG. 6A. Next, illustrated in FIG. 6B, a mold material 118 is deposited 502 to surround the fingerprint sensor device 102 and to fill a space between the fingerprint sensor device 102 and the sidewalls of the substrate recess 401, thereby mechanically attaching the fingerprint sensor device 102 to the substrate 108.

In the next step, illustrated in FIG. 6C, an electrical connection 114 is formed 504 between a connection pad 116 located on the fingerprint sensor device 102 adjacent to the sensing array and a corresponding connection pad of the substrate which connects the fingerprint sensor device 102 to the antenna 402. Finally, a protective layer 304 is deposited to cover the fingerprint sensor device 102 and the substrate 108. FIG. 6C also illustrates a bump on the backside of the fingerprint sensor module, i.e. a substrate connection pad, for connecting to external circuitry.

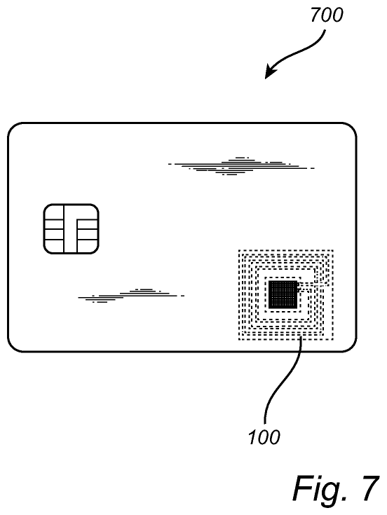

FIG. 7 schematically illustrates a smart card 700 comprising a fingerprint sensor module 100 arranged in an opening of the smartcard 700. The fingerprint sensor module 100 is communicatively coupled to integrated circuitry of the smartcard 700 so that an identity of a user can be verified. The opening of the smart card 700 may be a through opening or a recess. Moreover, the opening may have T-shaped profile and the fingerprint sensor module 100, 400 may have a corresponding T-shaped profile to fit into the T-shaped opening of the smart card 700, thereby simplifying an assembly process.

Even though the invention has been described with reference to specific exemplifying embodiments thereof, many different alterations, modifications and the like will become apparent for those skilled in the art. Also, it should be noted that parts of the method and module may be omitted, interchanged or arranged in various ways, the method and module yet being able to perform the functionality of the present invention.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. A fingerprint sensor module comprising:
a fingerprint sensor device comprising a sensing array consisting of a plurality of sensing elements, the sensor device being configured to acquire an image of a finger placed on a sensing surface of the fingerprint sensor module;
a substrate comprising an opening;
wherein the fingerprint sensor device is arranged in the opening of the substrate and wherein the substrate comprises an antenna embedded in the substrate, the antenna being electrically connected to the fingerprint sensor device.

2. The fingerprint sensor module according to claim 1, wherein the antenna is arranged to encircle the opening comprising the fingerprint sensor device.

3. The fingerprint sensor module according to claim 1, wherein the antenna is arranged below the fingerprint sensor device, on a side of the fingerprint sensor device opposite the side comprising the sensing array.

4. The fingerprint sensor module according to claim 1, wherein the substrate comprises a plurality of conductive layers, and wherein the antenna is formed in said plurality of conductive layers of the substrate.

5. The fingerprint sensor module according to claim 1, wherein the substrate is a laminate substrate comprising a plurality of carrier layers interspaced with a plurality of electrically conductive layers.

6. The fingerprint sensor module according to claim 5, wherein the substrate is an epoxy-based laminate substrate.

7. The fingerprint sensor module according to claim 1, wherein the substrate comprises a glass or ceramic material having a plurality of electrically conductive layers embedded therein.

8. The fingerprint sensor module according to claim 1, wherein the opening of the substrate is a recess in the substrate.

9. The fingerprint sensor module according to claim 1, wherein the opening of the substrate is a through hole through the substrate.

10. The fingerprint sensor module according to claim 1, wherein the fingerprint sensor device comprises at last one connection pad located adjacent to the sensing array, and wherein the fingerprint sensor device is electrically connected to the antenna via the connection pad.

11. The fingerprint sensor module according to claim 10, wherein the electrical connection between the connection pad of the fingerprint sensor device and the antenna is formed as a conductive trace located in the same plane as the connection pad.

12. The fingerprint sensor module according to claim 11, wherein the connection pad is located in the same plane as the sensing array.

13. The fingerprint sensor module according to claim 10, further comprising a via connection in said substrate, wherein the connection pad is electrically connected to the antenna by means of the via connection.

14. The fingerprint sensor module according to claim 1, wherein the substrate comprises substrate connection pads for electrically connecting the fingerprint sensor module to external circuitry.

15. A smart card comprising a fingerprint sensor module according to claim 1, wherein the fingerprint sensor module is arranged in an opening of the smart card and electrically connected to smart card circuitry by means of a substrate connection pad.

16. A method for manufacturing a fingerprint sensor module, the method comprising:
providing a fingerprint sensor device comprising a sensing array consisting of a plurality of sensing elements, the sensor device being configured to acquire an image of a finger placed on a sensing surface of the fingerprint sensor module;
providing a substrate comprising an antenna embedded in the substrate, the substrate further comprising an opening for receiving the fingerprint sensor device;
arranging the fingerprint sensor device in the opening; and
forming an electrical connection between the fingerprint sensor device and the antenna.

17. The method according to claim 16, wherein the substrate opening is an opening through the substrate, the method further comprising:
arranging the substrate on a carrier;
arranging the fingerprint sensor device on the carrier in the substrate opening with the sensing array facing the carrier;
depositing a mold material covering a backside of the fingerprint sensor device and a backside of the substrate to mechanically attach the fingerprint sensor device to the substrate;
removing the carrier; and
forming an electrical connection between a connection pad located on the fingerprint sensor device adjacent to the sensing array and the antenna.

18. The method according to claim 16, wherein the substrate opening is a recess in the substrate, the method further comprising:
arranging the fingerprint sensor device in the substrate recess;
depositing a mold material surrounding filling a space between the fingerprint sensor device and the sidewalls of the substrate recess to mechanically attach the fingerprint sensor device to the substrate; and
forming an electrical connection between a connection pad located on the fingerprint sensor device adjacent to the sensing array and the antenna.
